(19) United States
(12) Patent Application Publication
(10) Pub. No.: US 2014/0265253 A1
(43) Pub. Date: Sep. 18, 2014

(54) Shopping Stick

(71) Applicant: Mariann Ingrasci, Pompano, FL (US)

(72) Inventor: Mariann Ingrasci, Pompano, FL (US)

(21) Appl. No.: 13/838,263

(22) Filed: Mar. 15, 2013

(51) Int. Cl. B62B 3/02; B62B 3/00

(52) U.S. Cl. CPC B62B 3/02; B62B 3/00
USPC 280/638; 280/47.35

(57) ABSTRACT

A mobile device for transporting items capable of hanging that includes a generally vertical member, a handle, and a base to which the vertical member is connected. The base includes at least three mobility apparatuses that permit the mobile device to be moved over a surface. The vertical member, which can be adjusted in height, includes at least one hook capable of catching and holding an item capable of hanging such as, for example, a shopping bag, a purse, or an umbrella. The handle can be gripped by a user to move the mobile device in a desired direction.

### FIELD OF THE INVENTION

The invention relates to devices for transporting items. More particularly, the invention relates to a mobile device capable of transporting bags and other items capable of being hung on the device.

### BACKGROUND

Shoppers, and particularly shoppers in malls or other locations having multiple stores and vendors, often face the difficult task of carrying numerous shopping bags, purses, umbrellas and other objects from store to store while shopping. The shopper's less convenient option is to make purchases in one or more stores, in a mall for example, and to carry some shopping bags containing purchased items to the shopper's car for storage before returning to the mall to complete the shopper's shopping. Transporting multiple shopping bags and other items becomes particularly difficult during the holidays (e.g., Christmas and Hanukkah) when numerous purchases must be made often in a mall setting that has a plurality of stores available for the shopper to browse within and make purchases.

A need exists for a mobile device capable of transporting shopping bags and other items, e.g., a purse, an umbrella, a diaper bag, or any other item capable of being hung on the device, while the shopper shops so that the shopper does not need to leave the mall periodically to store shopping bags in an automobile.

### SUMMARY

The invention relates to a mobile device for transporting items capable of hanging that includes a generally vertical member, a handle, and a base to which the vertical member is connected. The base can include at least three mobility apparatuses that permit the mobile device to be moved over a surface, e.g., a floor, an elevator floor, conventional or escalator steps, or a parking lot. The vertical member, which can be adjusted in height, includes at least one hook, and in exemplary embodiments, a plurality of hooks, capable of catching and holding an item capable of hanging such as, for example, a shopping bag, a purse, or an umbrella. The handle can be gripped by a user to steer and move the mobile device in a desired direction.

Accordingly, the invention features a mobile device for transporting items capable of hanging. The device can include a generally vertical member having at least one hook capable of catching and holding an item capable of hanging; a handle for manual gripping attached to the vertical member; and a base to which the vertical member is connected. The base can include at least three mobility apparatuses.

In another aspect, the invention can feature the at least one hook of the vertical member including a plurality of hooks.

In another aspect, the invention can feature the at least one hook being curved upward so as to catch and hold the item capable of hanging.

In another aspect, the invention can feature the item capable of hanging including at least one item selected from among: a shopping bag, a purse, an umbrella, or any other item capable of being hung.

In another aspect, the invention can feature the base further including at least one bumper.

In another aspect, the invention can feature the at least one bumper including a soft shock absorption material that does not scratch, dent, or otherwise damage a surface of an object contacted by the base.

In another aspect, the invention can feature the at least three mobility apparatuses including wheels.

In another aspect, the invention can feature the at least three mobility apparatuses including rollers.

In another aspect, the invention can feature the at least three mobility apparatuses including four or five mobility apparatuses.

In another aspect, the invention can feature the base further including at least one stopper apparatus for restricting the mobility of the mobile device so that the mobile device is locked temporarily in a fixed position.

In another aspect, the invention can feature the at least one stopper apparatus being capable of being locked and unlocked to restrict or unrestrict the mobility of the mobile device via manipulation of an actuating device installed on the handle.

In another aspect, the invention can feature the vertical member being adjustable in height.

In another aspect, the invention can feature the vertical member including an outer cylindrical member and an inner cylindrical member sized to fit slidably within the inner circumference of the outer cylindrical member.

In another aspect, the invention can feature the vertical member further including a tension adjuster installed near an exit point where the inner cylindrical member protrudes in exiting the outer cylindrical member, wherein the tension adjuster permits the inner cylindrical member to be moved to a desired depth inside the outer cylindrical member and fixed in position once a desired height of the vertical member is attained.

In another aspect, the invention can feature the inner cylindrical member being attached to the base so that the outer cylindrical member is slidably adjustable to a desired depth relative to the inner cylindrical member that is fixed in position on the base.

In another aspect, the invention can feature the outer cylindrical member being attached to the base so that the inner cylindrical member is slidably adjustable to a desired depth relative to the outer cylindrical member that is fixed in position on the base.

In another aspect, the invention can feature the handle being foldable and being attached to a top end of the vertical member.

In another aspect, the invention can feature the handle including a grip.

In another aspect, the invention can feature the vertical member being removable from the base for storage and transport of the mobile device.

The invention can also feature a mobile device for transporting items capable of hanging. The device can include a generally vertical member including at least one hook capable of catching and holding an item capable of hanging; a handle for manual gripping attached to the vertical member; and a base to which the vertical member is connected. The base can include at least three mobility apparatuses.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a side elevational view of a mobile device for transporting items capable of hanging.

FIG. 2 is a side elevational view of a base of the device of FIG. 1 with stoppers shown in an upward position so as not to restrict the mobility of the device.

FIG. 3 is a bottom view of the base of the device of FIG. 1.

FIG. 4 is a side elevational view of the base of the device of FIG. 1 with the stoppers shown in an downward position to restrict the mobility of the device.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides a shopping stick, which is a mobile device for transporting items capable of hanging, such as the device shown in FIG. 1. The shopping stick may be used to provide additional stability and carrying capacity to a user, advantageously making a shopping experience more comfortable and convenient. Generally, the shopping stick includes a base, a pole attached to the base with hooks, and a handle. The base includes wheels, stoppers, and a bumper.

The shopping stick includes a base at the bottom of the device as shown in FIG. 2. Preferably, the base may be circular with a diameter of approximately one foot. However, additional embodiments may be different sizes and/or shapes, such as oval or rectangular. A bumper may be located about the circumference or perimeter of the base to provide some protection from the shopping stick bumping into objects. The bumper may be rubber or a similar material. A plurality of wheels may be attached to a bottom surface of the base as shown in FIG. 3. The wheels provide mobility for the base, allowing a user to push the shopping stick around during use. The wheels may be constructed from a solid material, such as rubber, or inflatable materials, such as tires.

In a specific example, four wheels may be included at the bottom of the base. The wheels may be constructed from solid rubber. Each of the four wheels may be positioned at an approximately equal distance from the center of a circular base, with the radial position of each wheel being offset by 90 degrees from the neighboring wheel. In this configuration, a wheel would be located at 0, 90, 180, and 270 degrees about the circular base. Optimally, the wheels are not positioned around the circumference of the base.

The base may also include stoppers, which may be positioned around the circumference of the base. The stoppers may be hinged, such that they are foldable from an outward facing position, as shown in FIG. 2, to a downward facing position, as shown in FIG. 4. When in the outward facing position, the stopper will not interfere with the mobility of the shopping stick. Conversely, when the stoppers are configured in the downward facing position, as shown in FIG. 4, mobility of the shopping stick may be restricted to provide increased stability.

In the specific example, four stoppers may be located about the circumference of the base. The stoppers may be constructed from a solid material, such as rubber. Each of the four stoppers may be positioned at an approximately equal distance the circumference of a circular base, with the radial position of each stopper being offset by 90 degrees from the previous stopper. Each stopper may also be offset approximately 45 degrees from each wheel. In this configuration, a stopper would be located at 45, 135, 225, and 315 degrees about the circular base.

A pole may extend upwardly from the base. A bottom end of the pole may attach to the base, for example, at the center of a top surface of the base. A top end of the pole may terminate at a handle. Optionally, the pole may include an inner pole and an outer pole to provide height adjustability. The inner pole may be located at least partially within the outer pole. The inner pole may be able to slide to a variable depth within the outer pole, wherein the inner pole penetrating a deeper depth results in a shorter pole. A tension adjuster may be located at the point where the inner pole exits the outer pole. The tension adjuster may be adjusted restrict or allow movement of the inner pole relative to the outer pole, essentially locking a desired height of the pole.

The pole may include a strap, which may run the length of the pole. The pole may also include one or more button magnets. For example, a first button magnet may be included at the top end of the pole and a second button magnet may be included at the bottom end of the pole. Additional button magnets may be located elsewhere on the shopping stick.

A number of hooks may be positioned on the pole. Preferably, the hooks are strong enough to carry one or more objects, such as a filled shopping bag. Hooks may be located on the pole at various heights and locations. Optionally, the hooks may be spaced 90 or 180 degrees apart from one another about a circumference at a certain height of the pole. In an example with an inner pole and outer pole, a first set of hooks may be located near the top of the inner pole, as not to obstruct the insertion of the inner pole into the outer pole. A second set of hooks may be located on the outer pole. Additional sets of hooks may be located at various other positions on the pole.

A handle is attached to the top end of the pole, preferably oriented perpendicular to the pole. The handle may have a first end nearest the pole and a second end opposite the pole. A grip may be positioned on the handle, which may encircle the handle. The grip may be made of rubber or similar material.

In one embodiment, the handle may be a separate component from the pole. The first end of the handle may attach to the top end of the pole, for example, by inserting the pole into a hole or slot on the bottom of the first end of the handle. The handle may then extend outwardly from the pole. In another embodiment, the handle may be an extension of the pole. Here, the first end of the handle may be a bend in the top end of the pole. After the bend at its first end, the handle may extend outwardly from the pole to its second end.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A mobile device for transporting items capable of hanging, the device comprising:
a generally vertical member comprising at least one hook capable of catching and holding an item capable of hanging;
a handle for manual gripping attached to the vertical member; and
a base to which the vertical member is connected, the base comprising at least three mobility apparatuses.

2. The mobile device of claim 1, wherein the at least one hook of the vertical member comprises a plurality of hooks.

3. The mobile device of claim 1, wherein the at least one hook is curved upward so as to catch and hold the item capable of hanging.

4. The mobile device of claim 1, wherein the item capable of hanging comprises at least one item selected from the group consisting of: a shopping bag, a purse, an umbrella, and any other item capable of being hung.

5. The mobile device of claim 1, wherein the base further comprises at least one bumper.

6. The mobile device of claim 5, wherein the at least one bumper comprises a soft shock absorption material that does not scratch, dent, or otherwise damage a surface of an object contacted by the base.

7. The mobile device of claim 1, wherein the at least three mobility apparatuses comprise wheels.

8. The mobile device of claim 1, wherein the at least three mobility apparatuses comprise rollers.

9. The mobile device of claim 1, wherein the at least three mobility apparatuses comprises four or five mobility apparatuses.

10. The mobile device of claim 1, wherein the base further comprises at least one stopper apparatus for restricting the mobility of the mobile device so that the mobile device is locked temporarily in a fixed position.

11. The mobile device of claim 1, wherein the at least one stopper apparatus is capable of being locked and unlocked to restrict or unrestrict the mobility of the mobile device via manipulation of an actuating device installed on the handle.

12. The mobile device of claim 1, wherein the vertical member is adjustable in height.

13. The mobile device of claim 1, wherein the vertical member comprises an outer cylindrical member and an inner cylindrical member sized to fit slidably within the inner circumference of the outer cylindrical member.

14. The mobile device of claim 13, wherein the vertical member further comprises a tension adjuster installed near an exit point where the inner cylindrical member protrudes in exiting the outer cylindrical member, wherein the tension adjuster permits the inner cylindrical member to be moved to a desired depth inside the outer cylindrical member and fixed in position once a desired height of the vertical member is attained.

15. The mobile device of claim 13, wherein the inner cylindrical member is attached to the base so that the outer cylindrical member is slidably adjustable to a desired depth relative to the inner cylindrical member that is fixed in position on the base.

16. The mobile device of claim 13, wherein the outer cylindrical member is attached to the base so that the inner cylindrical member is slidably adjustable to a desired depth relative to the outer cylindrical member that is fixed in position on the base.

17. The mobile device of claim 1, wherein the handle is foldable and is attached to a top end of the vertical member.

18. The mobile device of claim 1, wherein the handle comprises a grip.

19. The mobile device of claim 1, wherein the vertical member is removable from the base for storage and transport of the mobile device.

20. A mobile device for transporting items capable of hanging, the device comprising:
a generally vertical member comprising at least one hook capable of catching and holding an item capable of hanging;
a handle for manual gripping attached to the vertical member; and
a base to which the vertical member is connected, the base comprising at least three mobility apparatuses.
